(19) United States
(12) Patent Application Publication
(10) Pub. No.: US 2009/0017650 A1
(43) Pub. Date: Jan. 15, 2009

(54) Electrical connector having improved electrical contacts

(75) Inventor: Wen-Yi Hsieh, Tu-cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/218,365

(22) Filed: Jul. 14, 2008

(30) Foreign Application Priority Data
Jul. 12, 2007 (CN) 200720040743.7

(51) Int. Cl. H01R 12/00

(52) U.S. Cl. 439/82

(57) ABSTRACT

An electrical connector (100) for electrically connecting an electronic package (8) with a circuit substrate comprising a housing assembly with a plurality of first passageways (90) and a plurality of contacts (1) received in the housing assembly, the first passageways (90) comprise a back wall (902), a front wall (901) and two side walls (903) connecting with the back wall (902) and the front wall (901), the contact (1) comprises a base portion (10) defining a plane extending along the back wall (902), a contacting portion (11) extending upwardly from one end of the base portion (10), a tail portion (13) extending downwardly from the other end of the base portion (10) and a retention portion (12) extending away from the plane.

### BACKGROUND OF THE INVENTION

1. Field of the Invention

The present invention relates to an electrical connector, and particularly to an electrical connector for electrically connecting electronic packages, such as Land Grid Array (LGA) Central Processing Units (CPU), with circuit substrate, such as printed circuit boards (PCB).

2. Description of the Prior Art

Referring to FIGS. 13-14, a conventional electrical connector 100′ for electrically connecting a CPU (not shown) with a PCB (not shown) is illustrated. The electrical connector 100′ comprises an insulative housing 15′ and a plurality of contacts 1′ received in the insulative housing 15′. The insulative housing 15′ defines a plurality of passageways 151′ for receiving the contacts 1′. The contacts 1′ comprises a body portion 10′ extending along a vertical direction, a spring portion 11′ extending upwardly from the upper end of the body portion 10′, a retaining portion 12′ extending downwardly from the lower end of the body portion 10′ and soldering portion 13′ extending downwardly from the retaining portion 12′. The retaining portion 12′ defines one or more barbs 120′ on the side of the retaining portion 12′, the retaining portion 12′ is a plate like configuration.

The width of the retaining portion 12′ with a plate configuration is thin, and due to the technology of punch, the width of the passageway 151′ is larger than that of the contact 1′ in the direction of X, so a gap 14′ exits between the retaining portion 12′ and the insulative housing 15′ in the direction of X, the gap 14′ make the contact 1′ incline easily when a force exerted on the contact 1′.

In view of the above, a new electrical connector that overcomes the above-mentioned disadvantages is desired.

### SUMMARY OF THE INVENTION

Accordingly, an object of the present invention is to provide an electrical connector having improved electrical contacts can securely positioned in the insulative housing.

To fulfill the above-mentioned object, an electrical connector for electrically connecting an electronic package with a circuit substrate comprising a housing assembly with a plurality of first passageways and a plurality of contacts received in the housing assembly, the first passageways comprise a back wall, a front wall and two side walls connecting with the back wall and the front wall, the contact comprises a base portion defining a plane extending along the back wall, a contacting portion extending upwardly from one end of the base portion, a tail portion extending downwardly from the other end of the base portion and a retention portion extending away from the plane.

Other objects, advantages and novel features of the invention will become more apparent from the following detailed description when taken in conjunction with the accompanying drawings.

### BRIEF DESCRIPTION OF THE DRAWINGS

FIG. 1 is an assembled view of an electrical connector of the present invention in the locking position;

FIG. 2 is an exploded view of the electrical connector of the present invention;

FIG. 3 is an enlarged view of the stock block shown in FIG. 2;

FIG. 4 is an enlarged view of the base shown in FIG. 2;

FIG. 5 is an exploded view of the electrical connector of the present invention, showing the cover is detached from the electrical connector;

FIG. 6 is an isometric view of the contact of the present invention;

FIG. 7 is an view of the contact in FIG. 6 be assembled with an insulative housing, showing the relative of the contact and the first passageway;

FIG. 8 is an assembled view of the electrical connector of the present invention in the releasing position;

FIG. 9 is a top view of the electrical connector of the present invention in the releasing position;

FIG. 10 is a sectional view of the electrical connector of FIG. 9 along the line A-A;

FIG. 11 is a top view of the electrical connector of the present invention in the locking position;

FIG. 12 is a sectional view of the electrical connector of FIG. 1 along the line B-B;

FIG. 13 is an isometric view of a conventional contact; and

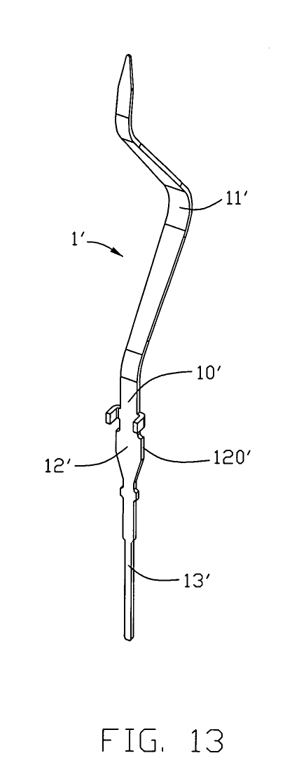

FIG. 14 is an view of the contact in FIG. 13 be assembled with an insulative housing, showing the relatives of the contact and the first passageway.

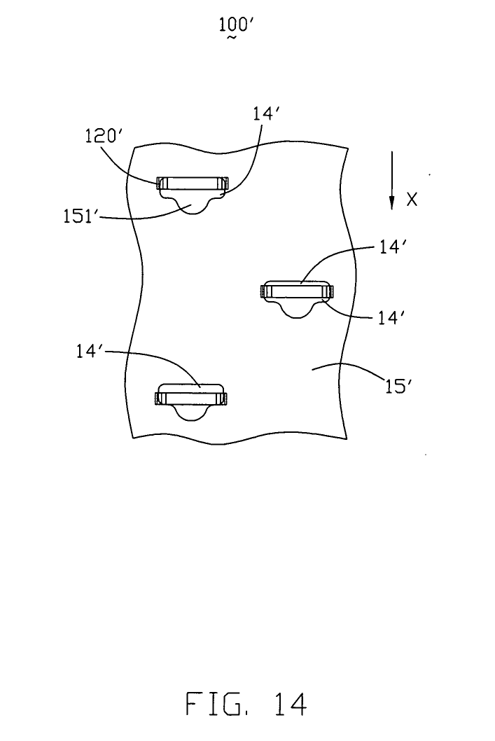

### DETAILED DESCRIPTION OF THE PREFERRED EMBODIMENT OF THE INVENTION

Reference will now be made to the drawings to describe the present invention in detail.

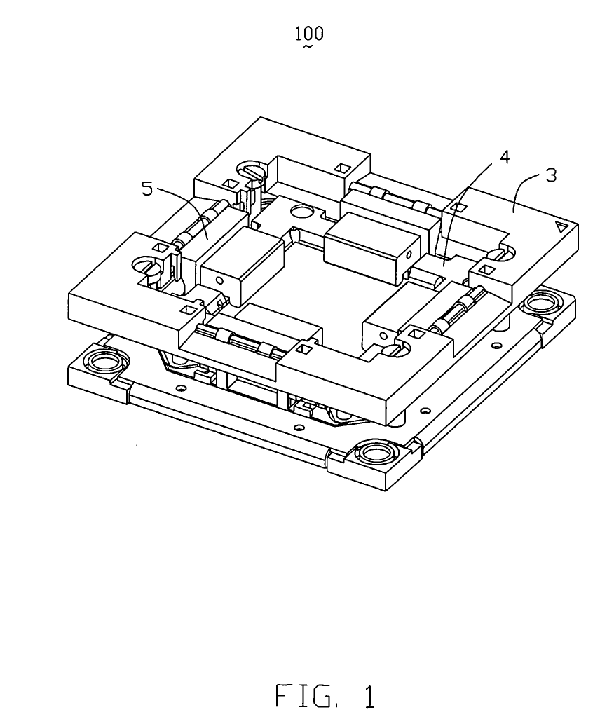

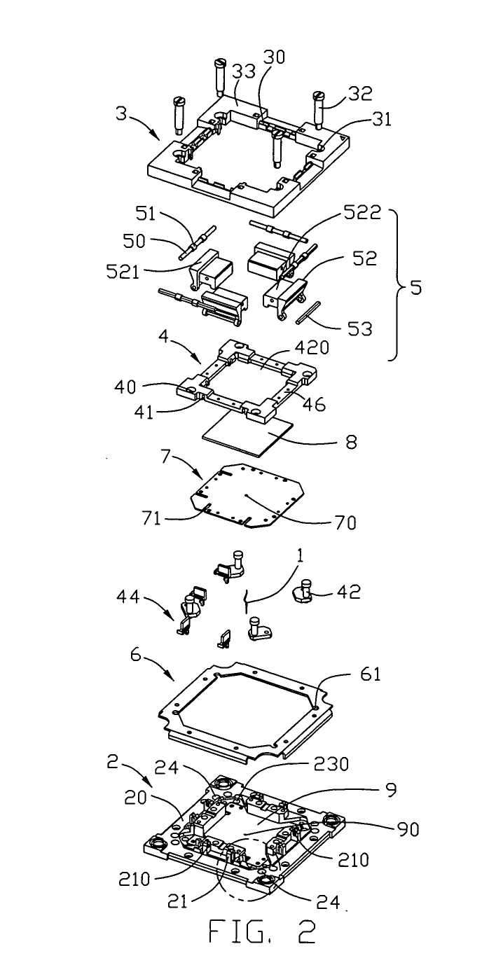

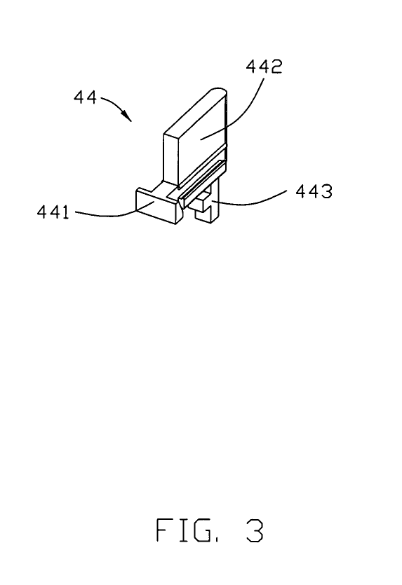

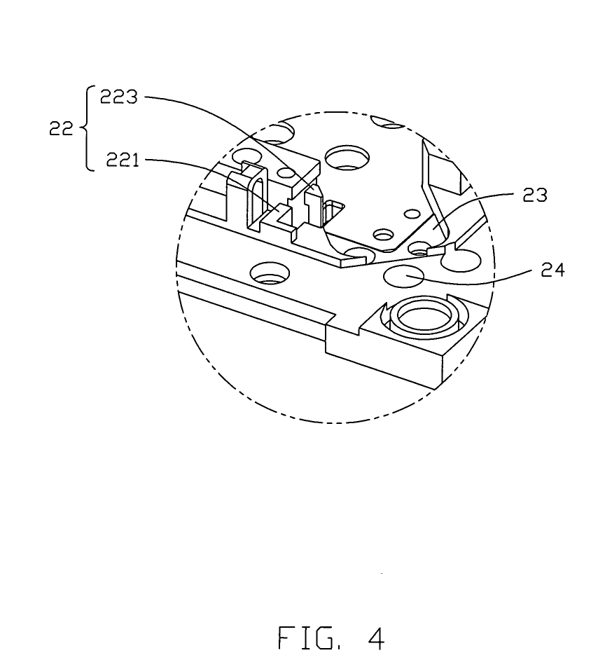

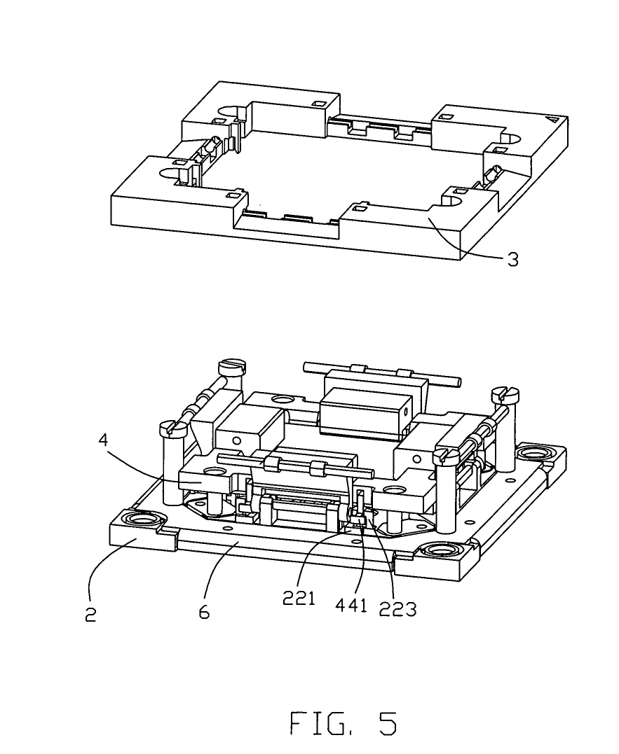

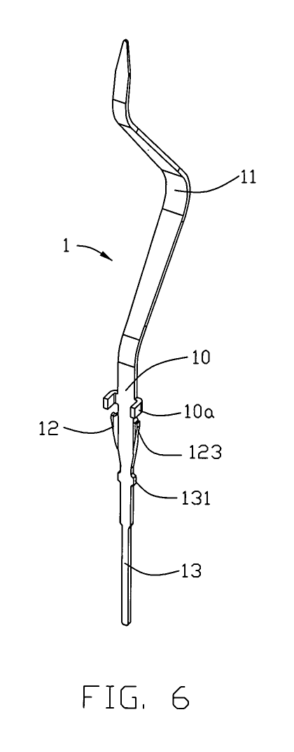

Referring to FIGS. 1 to 7, an electrical connector 100 for electrically connecting an electronic package, such as a central processing unit (CPU) 8, with a circuit substrate, such as a printed circuit board (PCB) (not shown) comprises a base 2 with a square configuration, a number of contacts 1, a cover 3 and a frame 4 set on the base 2, a number of locking assembly 5, a reinforcement 6, a receiving board 9, and an orientation board 7 for receiving the contacts 1.

The base 2 is made of plastic and comprises a body portion 20, a blocking portions 22, and a plurality of fixing portions 21 extending upwardly from the body portion 20. The body portion 20 defines a plurality of first holes 24. The fixing portions 21 are parallel with each other and each comprises an aperture 210. The blocking portions 22 are located on one side of the fixing portions 21 and each comprises a supporting portion 221 and an interlocking portion 223.

The cover 3 is set on the base 2 and comprises four first walls 33. The first walls 33 each defines a recess 30 and a pair of third holes 31 on the two side of the recess 30. The frame 4 comprises four second walls 46 and a receiving space 420 formed by the second walls 46 for receiving the CPU 8. The second walls 46 each defines two first notches 41 and two fourth holes 40. The frame 4 is assembled to the base 2 by four connecting members 42.

The locking assembly 5 set on the base 2 and the cover 3 comprises a first shaft 50 located in the recess 30 of the cover 3, a idler wheel 51 positioned on the shaft 50, a number of locking members 52 and a number of second shafts 53 for connecting the locking members 52 with the base 2. The locking member 52 comprises a connecting portion 521 and a pressing portion 522 extending from the connecting portion 521 for pressing the CPU 8. The connecting portion 521 is connected with the fixing portions 21 of the base 2 by the second shafts 53.

The reinforcement 6 is assembled on the base 2 and defines a number of second holes 61 according to the first holes 24 and the third holes 31. The fastening members 32 go through the third holes 31, the second holes 61 and the first holes 24 to connect the reinforcement 6 and the cover 3 with the base 2. The orientation board 7 is used for supporting the CPU 8 and comprises a plurality of second passageways 70 for orientation the contacts 1, and a number of second notches 71 according to the first notches 41. The orientation board 7 is assembled to the frame 4 by the fixing members 44. The fixing members 44 comprises a horizontal portion 441, a vertical portion 442 extending from the horizontal portion 441 and a protruding portion 443 extending from the vertical portion 442. The horizontal portion 441 is located between the supporting portion 221 and the interlocking portion 223 to restrict the horizontal movement of the second shaft 53. The vertical portion 442 is inserted into the first notch 41 and the second notch 71 to connect the frame 4 with the orientation board 7. The protruding portion 443 is interlocked with the base 2 for securely locating on the base 2.

The receiving board 9 is located on the bottom side of the base 10 and defines a plurality of first passageways 90 for receiving the contacts 1. The first passageways 90 comprises a back wall 902 with a plane configuration, a front wall 901 and two side walls 903 connected with the front wall 901 and the back wall 902. The middle of the front wall 901 define a recess (not labeled) in the direction far from the back wall 902. The first passageways 90 with this configuration is easy to punch.

The contacts 1 comprises a plate like base portion 10, a contacting portion 11 extending upwardly from one end of the base portion 10 and a tail portion 13 extending downwardly from the other end of the base portion 10. The tail portion 13 defines a pair of reinforcement portions 131 for enlarging the retention affection of the contacts 1 in the PCB.

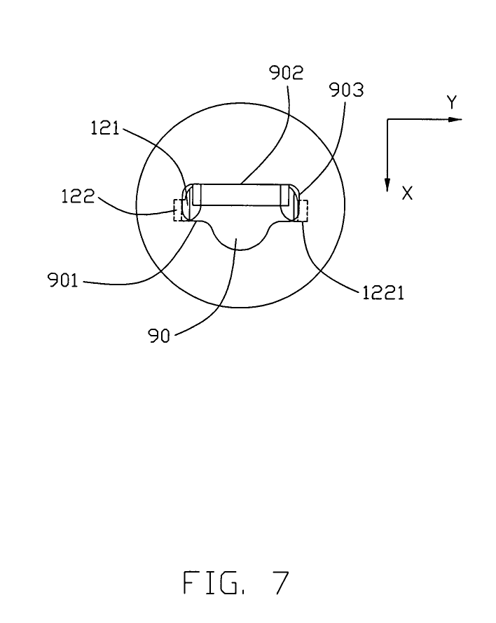

The contacts 1 further comprises a retention portion 12 extending away from a plane defined by the base portion 10. The retention portion 12 comprises a bending portion 121 extending curvedly from the base portion 10 and an interference portion 122 connecting with the bending portion 121. The interference portion 122 is parallel with the base portion 10 and the retention portion 12 is not coplanar with the base portion 10. The retention portion 12 defines a leading surface 123 for touching with the side walls 903 and leading the contacts 1 assembled to the first passageways 90 to make the base portion 10 abutting against the back wall 902. The interference portion 122 is interfere with the side walls 903 of the first passageways 90 and clung with the front wall 901. The base portion 10 defines a pair of extending portions 10a near the retention portion 12 for preventing the distortion of the contacts 1 when assembled into the first passageways 90. Referring to FIG. 7, the bending portion 121 enlarges the width of the contacts 1 in the direction X and the interference portion 122 is parallel with the base portion 10. Thus, the contacts 1 can both abut against the front wall 901 and the back wall 902, then the contacts 1 are positioned in the first passageways 90.

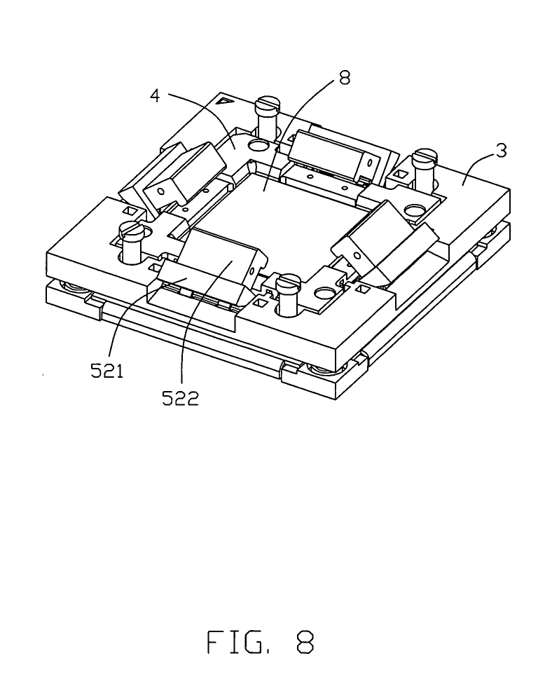

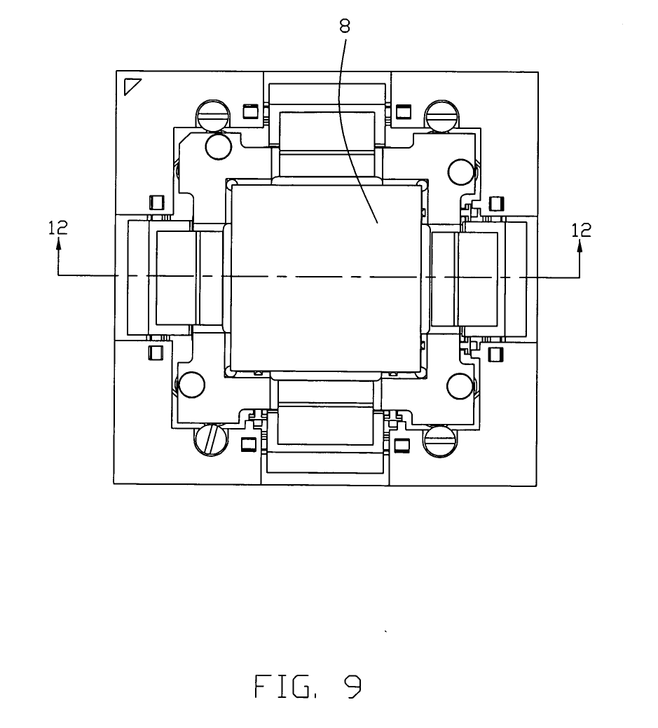

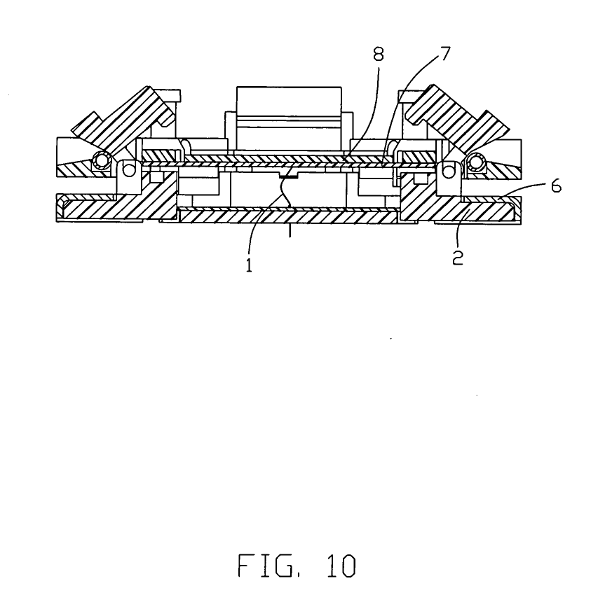

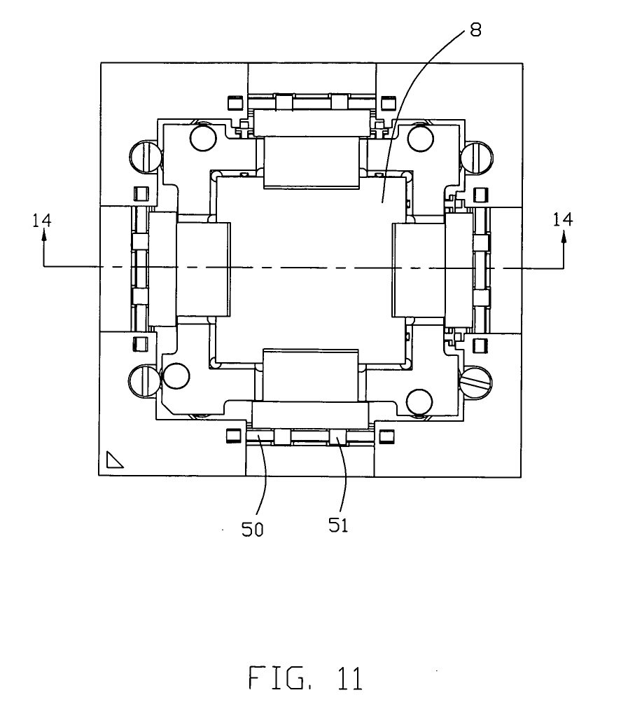

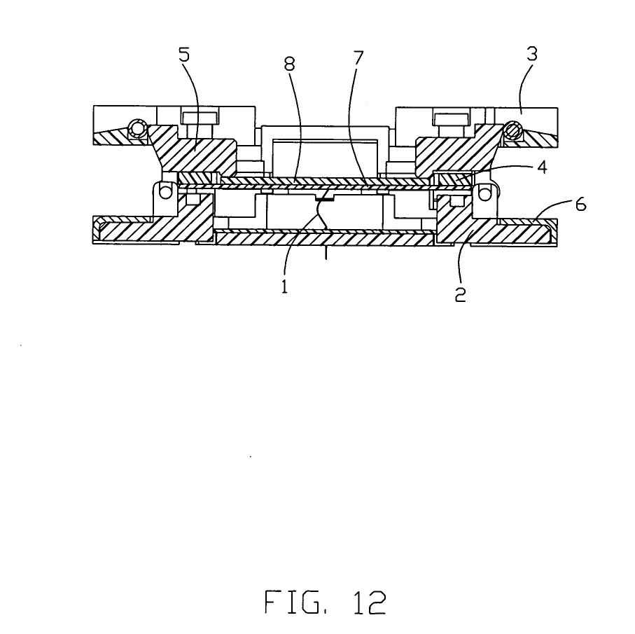

Referring to FIGS. 8-12, press the cover 3 downwardly, at the same time, the first shaft 50 and the idler wheel 51 will push the locking members 52, when the cover 3 is touched with the reinforcement 6. The idler wheel 51 pushes the second shaft 53 to rotate, and the locking members are in an open position so that the CPU 8 can be put in the receiving space 420. After release the cover 3, the cover 3 will move upwardly. When the cover moves to the highest position, the locking members 52 are in a close position and press on the CPU 8 to ensure a good connection between the CPU 8 and the contacts 1. The locking members 52 are set on the base 2 in a symmetry mode to make a symmetrical force on the CPU 8.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector for electrically connecting an electronic package with a circuit substrate, comprising:
a housing assembly comprising a plurality of first passageways, the first passageways comprising a back wall, a front wall and two side walls connecting with the back wall and the front wall; and
a plurality of contacts received in the housing assembly, the contact comprising a base portion defining a plane extending along the back wall, a contacting portion extending upwardly from one end of the base portion, a tail portion extending downwardly from the other end of the base portion and a retention portion extending away from the plane.

2. The electrical connector as claimed in claim 1, wherein the retention portion comprises a bending portion extending from the side of the plane and an interference portion connecting with the bending portion.

3. The electrical connector as claimed in claim 2, wherein the plane of the base portion is paralleled with the back wall of the first passageways and the interference portion is interfere with the side walls of the first passageway.

4. The electrical connector as claimed in claim 2, wherein the interference portion extending along a plane paralleled with the plane of the base portion.

5. The electrical connector as claimed in claim 1, wherein the retention portion defines a leading portion.

6. An electrical contact for electrically connecting an electronic package with a circuit substrate, comprising:
a base portion comprising a plane;
a contacting portion extending upwardly from the upper end of the base portion;
a tail portion extending downwardly from the lower end of the base portion; and
a retention portion extending away from the plane defined by the base portion.

7. The electrical contact as claimed in claim 6, wherein the retention portion comprises a bending portion extending from the side of the plane and an interference portion connecting with the bending portion.

8. The electrical contact as claimed in claim 7, wherein the interference portion extending along a plane which is parallel with the plane of the base portion.

9. The electrical contact as claimed in claim 8, wherein the retention portion defines a leading portion.

10. The electrical contact as claimed in claim 6, wherein the contact comprises a pair of extending portions near the retention portion.

11. The electrical contact as claimed in claim 6, wherein the tail portion defines a pair of reinforcement portions near the base portion.

12. An electrical contact for electrically connecting an electronic package with a circuit substrate, comprising:
a base portion comprising a plane;
a contacting portion extending upwardly from the upper end of the base portion;
a tail portion extending downwardly from the lower end of the base portion; and
a pair of retention portions formed on two opposite side edges of the base portion and extending from the plane in an offset manner to have corresponding edge sections of the retention portions located in another plane essentially parallel to said plane.
